(19) United States
(12) Patent Application Publication
(10) Pub. No.: US 2009/0122014 A1
(43) Pub. Date: May 14, 2009

(54) METHOD AND APPARATUS FOR PROCESSING CHARACTER-INPUT

(75) Inventor: Soo-kang Bae, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/241,735

(22) Filed: Sep. 30, 2008

Related U.S. Application Data
(60) Provisional application No. 60/987,173, filed on Nov. 12, 2007.

(30) Foreign Application Priority Data
Jan. 30, 2008 (KR) 10-2008-0009685

(51) Int. Cl. G06F 3/02

(52) U.S. Cl. 345/168

(57) ABSTRACT

Provided are a method and apparatus for processing character-input. The processing method includes receiving a first signal representing a classification of a character to be input and a second signal representing a key selected from a plurality of keys to which a character of the classification is assigned, requesting an external device for a first character code representing the character corresponding to the first signal and the second signal, receiving the first character code from the external device, and displaying the character corresponding to the first signal and the second signal based on the received first character code.

### CROSS-REFERENCE TO RELATED PATENT APPLICATION

This application claims priority from U.S. Provisional Patent Application No. 60/987,173, filed on Nov. 12, 2007, in the U.S. Patent and Trademark Office, and Korean Patent Application No. 10-2008-0009685, filed on Jan. 30, 2008, in the Korean Intellectual Property Office, the disclosures of which are incorporated herein in their entirety by reference.

### BACKGROUND OF THE INVENTION

1. Field of the Invention

Methods and apparatuses consistent with the present invention relate to processing character-input, and more particularly, to processing character-input using an external communication network.

2. Description of the Related Art

By virtue of the development of information and communication technologies, consumer electronics (CE) products have become widely popular over the years. Generally, CE products such as televisions (TVs) or set-top boxes are closely connected with a language of a country or region (hereinafter referred to as “local language”) where the CE products are to be sold. Thus, manufacturers of the CE products provide a character input device for inputting a local language to search for broadcasts as well as an instruction manual for the CE products in the relevant local language. The character input device functions by searching for a character code represented by a user's input and displaying a corresponding character on a display screen. In particular, in the case of combination type characters which are used in languages such as Korean, the character input device functions as an automata that can combine a consonant and a vowel into a character according to previous input as well as current input.

In the related art, since the number of service channels being broadcasted was limited, it was sufficient to install in a TV an input device, which allowed input of characters of the local language and a few other selected languages, wherein the selected languages are expected to be used. However, with recent developments in broadcasting technologies, a user can watch worldwide broadcasting. In particular, when a user inputs a desired key word and receives a response corresponding to the key word, like in the case of watching worldwide broadcasting, it is very uncomfortable and limiting to input only languages of a few countries, i.e., to use the related art inputting method. In addition, in order to meet an international standard such as an open internet protocol television (IPTV) instead of a local standard related to a predetermined country or region, it is preferable that CE products are manufactured so that languages of all countries can be input to the CE products. To achieve this, a plurality of character input devices are loaded in the CE products, thereby increasing the production cost due to the inclusion of character input devices that are not used.

To solve this problem, software providing a predetermined character input means is downloaded, and then is installed in CE products, like in the case of a current personal computer (PC). However, this method is disadvantageous in that a user must personally install the software and in that the cost required for after-sales services or the like is increased if the user fails to install the software. Further, since the size of memory storage space inside the CE products is limited, not all desired character input devices can be downloaded. Besides, costs are inevitably increased in order to download all the desired character input devices on the CE products.

As another character-inputting method, java script code functioning as an automata related to a predetermined character may be embedded in a web page. Using this method, when a user interfaces with a web site, the java script code is simultaneously interpreted. Thus, the user can input a predetermined classification of a character. However, since the user can input the character only in the website, the java script code functioning as the automata needs to be inserted to every website to which characters can be input. This is virtually impossible. Even if implemented, it results in long periods of time to load such web sites, thereby imposing a heavy burden on a corresponding network. In addition, it is impossible to accurately expect a user's input and then to provide an automata function related to the user's input. Thus, a plurality of automata functions need to be installed on each web site, thereby increasing the loading time of the web sites.

### SUMMARY OF THE INVENTION

The present invention provides a method and apparatus for processing character-input so that various classifications of characters can be input in consumer electronics (CE) products which are connectable to a network, and a method and apparatus for controlling character-input in CE products.

According to an aspect of the present invention, there is provided a method of processing character-input, the method including receiving a first signal representing a classification of a character to be input and a second signal representing a key selected from a plurality of keys to which a character of the classification is assigned; requesting an external device for a first character code representing the character corresponding to the first signal and the second signal; receiving the first character code from the external device; and displaying the character corresponding to the first signal and the second signal based on the received first character code.

The requesting may include transmitting information related to the classification of the character to be input based on the first signal and information related to the selected key based on the second signal to the external device.

The requesting may further include storing the information related to the selected key based on the second signal, and when a third signal, separate from the second signal, representing a key selected from the plurality of the keys to which a second character of the classification is assigned is received after receiving the second signal, the requesting comprises transmitting the stored information related to the selected key based on the second signal, and information related to the selected key based on the third signal to the external device.

The first character code may be a character code representing a third character that is a combined character of a first character and a second character, wherein the first character corresponds to the information related to the classification of the character to be input and the information related to the selected key based on the second signal and the second character corresponds to the information related to the classification of the character to be input and the information related to the selected key based on the third signal.

The receiving may include receiving the first signal representing the classification of the character to be input; requesting the external device for key mapping information relating characters of the classification represented by the first signal to the plurality of the keys used for inputting the characters; receiving the key mapping information from the external device; displaying information related to at least one character assigned to each respective key, based on the received key mapping information; and receiving the second signal representing the selected key among the plurality of the keys.

The method may further include determining whether the character-corresponding to the first signal and the second signal is capable of being independently processed, based on the received first signal, wherein the requesting is performed when it is determined that the character-corresponding to the first signal and the second signal is not capable of being independently processed.

The method may further include acquiring information related to the shapes of characters of the classification, wherein the displaying includes displaying the character-corresponding to the first signal and the second signal, based on the acquired information related to the shapes of the characters.

The method may further include receiving a character conversion signal for converting the displayed character into a different classification related to the displayed character; requesting the external device for a second character code representing a character of the different classification, which is related to the displayed character; receiving the second character code from the external device; and displaying the character of the different classification, which is related to the displayed character, based on the received second character code.

The method may be performed in an internet protocol television (IPTV).

According to another aspect of the present invention, there is provided a method of controlling an external apparatus which processes character-input, the method including receiving information related to a classification of a character that is selected based on a first selection signal transmitted from the apparatus and information related to a selected key based on a second selection signal transmitted from the external apparatus; acquiring a first character code representing a character corresponding to the first selection signal and the second selection signal, based on the information related to the classification of the character and the information related to the selected key; and transmitting the acquired first character code to the apparatus.

The information related to the selected key may include information related to the key that is currently selected and information related to a key that was previously selected, and the first character code represents a third character that is a combined character of a first character and a second character, wherein the first character corresponds to the information related to the classification of the character and the information related to the selected key that is currently selected and the second character corresponds to the information related to the classification information of the character and the information related to the key that was previously selected.

The method may further include receiving a request from the external apparatus for a second character code representing a different classification related to the third character; acquiring the second character code based on the first character code; and transmitting the second character code to the external apparatus.

The receiving may include receiving information related to the classification of the character based on the first selection signal; transmitting key mapping information relating characters of the selected classification to keys used for inputting characters; and receiving the information related to the selected key based on the second selection signal that is input according to the key mapping information.

According to another aspect of the present invention, there is provided an apparatus for processing character-input, the apparatus including an interface unit which receives a first signal representing a classification of a character to be input and a second signal representing a key selected from a plurality of keys to which a character of the classification is assigned; an information requesting unit which requests an external device for a first character code representing the character corresponding to the first signal and the second signal; a display unit which displays the character corresponding to the classification selection signal and the key selection signal; and a controlling unit which controls the display unit to display the character corresponding to the first signal and the second signal, when the first character code is received.

According to another aspect of the present invention, there is provided an apparatus for controlling another external apparatus for processing character-input, the apparatus including a receiving unit which receives information related to a classification of a character to be input that is represented based on a first selection signal transmitted from the external apparatus and information related to a selected key selection represented based on a second selection signal transmitted from the external apparatus; an information acquisition unit which acquires a first character code representing a character corresponding to the first selection signal and the second selection signal based on the information related to the classification of the character and the information related to the selected key; and a transmitting unit which transmits the first character code to the external apparatus.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a character input processing apparatus according to an exemplary embodiment of the present invention;

FIG. 2 is a block diagram of a controlling apparatus controlling a client to process character-input, according to an exemplary embodiment of the present invention;

FIG. 3 is a block diagram of a system including a client and an external server, according to an exemplary embodiment of the present invention;

FIG. 4A illustrates Korean characters assigned to keys used for inputting characters, according to an exemplary embodiment of the present invention;

FIG. 4B illustrates hiragana characters assigned to keys used for inputting characters, according to another exemplary embodiment of the present invention;

FIG. 5 is a flowchart of a method of processing character-input according to an exemplary embodiment of the present invention; and

FIG. 6 is a flowchart of a method of controlling a client processing character-input, according to an exemplary embodiment of the present invention.

### DETAILED DESCRIPTION OF THE INVENTION

Hereinafter, the present invention will be described in detail by explaining exemplary embodiments thereof with reference to the attached drawings.

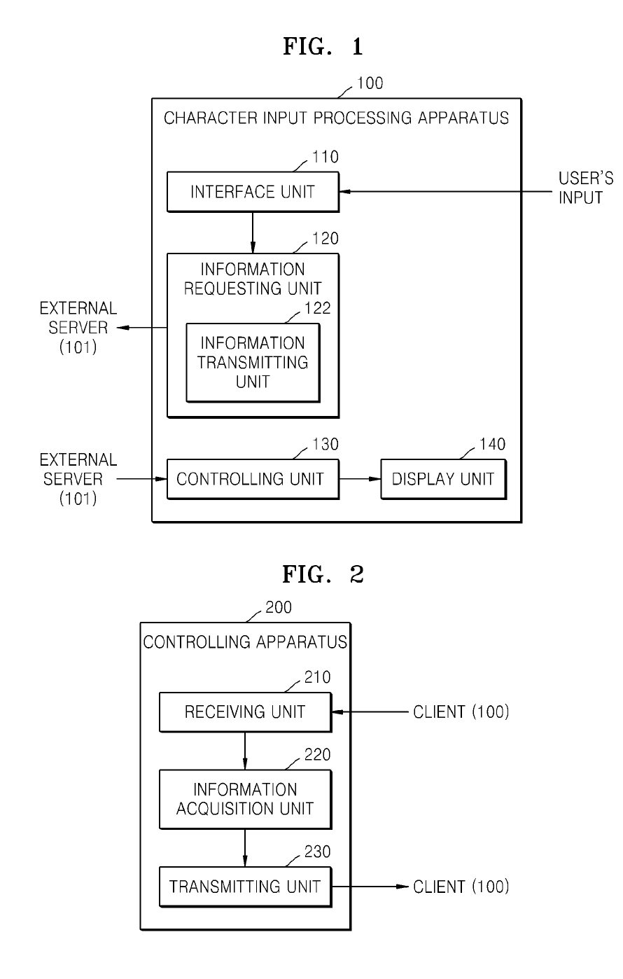

FIG. 1 is a block diagram of a character input processing apparatus 100 according to an exemplary embodiment of the present invention.

The character input processing apparatus 100 includes an interface unit 110, a display unit 140, an information requesting unit 120 and a controlling unit 130. The character input processing apparatus 100 may be a consumer electronics (CE) device such as an internet protocol television (IPTV) that can communicate with an external server 101.

The interface unit 110 receives a classification selection signal and a key selection signal from a user. The classification selection signal is a signal for selecting the classification of a character that is to be input. The character may be classified according to a kind of language, such as Korean, English or the like or may be classified according to a manner of inputting a character, such as a two set type or a three set type. In addition, the key selection signal is a signal which is generated by selecting a key from among keys used for inputting a character by the user. At least one character may be assigned to each key used for inputting characters, as determined according to the classification selection signal.

The interface unit 110 receives the classification and key selection signals by using various methods. For example, when the character input processing apparatus 100 is an IPTV, the interface unit 110 receives the classification and key selection signals via a key pad formed on a remote controller or via a virtual key pad provided on a touch screen.

The information requesting unit 120 requests the external server 101 for a character code representing a character corresponding to the received classification and key selection signals.

When the controlling unit 130 receives the character code representing the character corresponding to the classification and key selection signals, the controlling unit 130 controls the display unit 140 to display thereon the character corresponding to the classification and key selection signals based on the received character code. The character input processing apparatus 100 employs a character code set representing characters, such as UTF-8 or EUC-KR. The controlling unit 130 can specify a character to be displayed, based on the character code set and the received character code.

The display unit 140 displays the character corresponding to the classification and key selection signals received from the controlling unit 130.

Hereinafter, a method of processing character-input in the character input processing apparatus 100 will be described.

The interface unit 110 receives the classification selection signal for selecting the classification of a character that is to be input from a user. Before the user selects the classification of a character, a list including classifications of characters that can be selected by the user may be displayed.

When the user selects the classification of a character that is to be input, the controlling unit 130 controls the display unit 140 to display information regarding assignment of characters to keys based on key mapping information between keys used for inputting characters and characters of the selected classification. When the key mapping information does not exist, the information requesting unit 120 requests the external server 101 for the key mapping information.

The user checks the key mapping information between the keys and the characters, and then the user selects a key via the interface unit 110. When the user selects the key, a key value corresponding to the selected key is generated.

The information requesting unit 120 requests the external server 101 for the character code corresponding to the selected classification of the character and the selected key. The information requesting unit 120 may include an information transmitting unit 122 for transmitting information required for obtaining character codes to the external server 101.

The information transmitting unit 122 transmits information regarding the classification of the character selected based on the classification selection signal and information regarding the key selected based on the key selection signal to the external server 101. The key value generated in response to the key selection signal is transmitted as the information regarding the selected key.

In the meantime, the information transmitting unit 122 may transmit not only information regarding a key that is currently selected but also information regarding a key that is previously selected. This can be particularly applied when the user wants to input a combination type character such as those used in the Korean language. It is assumed that the user previously selects a key corresponding to an initial sound (consonant) and that the user currently selects a key corresponding a neutral vowel. Since an initial sound and a neutral vowel are combined to constitute one character in Korean, the information regarding the key that is previously selected together with the information regarding the key that is currently selected needs to be transmitted to the external server 101.

Thus, the information regarding the key that is currently selected is stored in a database (not shown) so as to be transmitted together with information regarding a key that will be selected in the near future. Simultaneously, the information transmitting unit 122 transmits the information regarding the key that is currently selected together with the information regarding the key that was previously selected and stored in the database (not shown) to the external server 101.

The external server 101 transmits the character code corresponding to the classification and key selection signals, based on the information transmitted from the information transmitting unit 122.

The character input processing apparatus 100 employs mapping information between a character code and information regarding the shape of a character, for distinguishing characters from each other. The information regarding the shape of a character is information required for displaying the character. When the controlling unit 130 receives a character code from the external server 101, the controlling unit 130 searches for information regarding the shape of a character corresponding to the received character code based on the mapping information, and displays the character on the display unit 140 based on the information regarding the shape of the character. Thus, the user can verify whether the character, which he or she has input is accurate, via the display unit 140.

The user may make request for the displayed character to be converted into a different classification of a character. For example, in the case of Japanese, a character having the same meaning can be expressed by ‘Hiragana’, ‘Katakana’ or in the form of a ‘Chinese character’. Hiragana is a character used by Japanese. The user inputs the character by using ‘Hiragana’, and then requests the character to be converted into ‘Katakana’ or a ‘Chinese character’. A character conversion signal is a signal for converting the displayed character into a different classification related to the displayed character.

For convenience of description, hereinafter, a character code representing the displayed character is referred to as a first character code, and a character code representing the different classification of the subject character related to the displayed character is referred to as a second character code.

When the interface unit 110 receives the character conversion signal, the information requesting unit 120 requests the external server 101 for the second character code. At this time, the information requesting unit 120 may transmit the first character code to the external server 101 via the information transmitting unit 122.

The external server 101 obtains the second character code based on the first character code, and transmits the obtained second character code to the character input processing apparatus 100.

The controlling unit 130 controls the display unit 140 to display a character of the different classification, which is related to the initial character, based on the second character code on the display unit 140. As described above, the controlling unit 130 controls the display unit 140 to display a character corresponding to the second character code based on the information regarding the shape of the character.

Alternatively, the controlling unit 130 may receive character codes corresponding to a plurality of characters related to the displayed character from the external server 101. When a list including a plurality of convertible character codes is displayed based on the received character codes, the user selects a character, to which the displayed character is to be converted, from the list.

The above-described method is useful in the case where a character to be input has many related characters, like in the case of the relationship between Korean and Chinese characters. For example, when a user inputs the sound of a Chinese character by using Korean, a list including all convertible Chinese characters (i.e. ones having the same input sound) is displayed. By selecting the Chinese character to be converted from the list, the user can easily input the Chinese character.

According to the current embodiment, although the character input processing apparatus 100 does not include a character input device equipped therein, the character input processing apparatus 100 can easily input/output the character by receiving the character code based on the received classification and key selection signals from the external server 101. However, when a character input device is included in the character input processing apparatus 100, the character input processing apparatus 100 does not have to receive the character code corresponding to the classification and key selection signals from the external server 101.

When the character input processing apparatus 100 further includes a determining unit (not shown), the determining unit can determine whether the classification of a character that is selected based on the received classification selection signal can be independently processed. When the character input processing apparatus 100 can independently process the classification signal received from the user, the information requesting unit 120 does not request the external server 101 for the character code. However, when the character input processing apparatus 100 cannot independently process the classification signal, the information requesting unit 120 requests the external server 101 for the character code corresponding to the classification and key selection signals.

FIG. 2 is a block diagram of a controlling apparatus 200 controlling a client 100 to process character input, according to an exemplary embodiment of the present invention.

The controlling apparatus 200 includes a receiving unit 210, an information acquisition unit 220, and a transmitting unit 230.

The receiving unit 210 receives information regarding the classification of a character that is selected based on a first selection signal transmitted from the client 100. The client 100 may be, e.g., the character input processing apparatus 100 shown in FIG. 1. In addition, the receiving unit 210 receives information regarding a key that is selected based on a second selection signal transmitted from the client 100. Hereinafter, for convenience of description, the information regarding the classification of the character that is selected is referred to as character classification information, and the information regarding the selected key is referred to as key selection information.

The information acquisition unit 220 acquires a character code of a character corresponding to the first selection signal and the second selection signal, based on the character classification information and the key selection information.

The transmitting unit 230 transmits the acquired character code to the client 100.

The controlling apparatus 200 controls the client 100 as follows.

When a user selects the classification of a character to be input via the first selection signal, the receiving unit 210 receives the character classification information representing the classification of a character that is selected by the user. When the character classification information is received, the transmitting unit 230 transmits key mapping information to the client 100, wherein the key mapping information is stored in a database (not shown). The key mapping information includes mapping information between characters of the selected classification and keys used for inputting the characters.

The client 100 provides information regarding at least one character assigned to each key to the user, based on the received key mapping information. The user selects a desired key with reference to the provided information. When the user selects the desired key, the key selection information regarding the key selected by the user is received by the receiving unit 210 from the client 100.

In the meantime, the key selection information may include information regarding a key that is currently selected and information regarding a key that is previously selected. In particular, the information regarding the key that is previously selected is required in the case of a combination type character such as those used in Korean.

The information acquisition unit 220 acquires a character code corresponding to a third character that is a combined character of a first character and a second character, wherein the first character corresponds to the character classification information and the information regarding the key that is currently selected and the second character corresponds to the character classification information and the information regarding the key that is previously selected.

The transmitting unit 230 transmits the character code representing the third character to the client 100.

The third character may be provided to the user via a display unit (not shown) included in the client 100. The user may select a button ‘conversion’ in order to convert the third character into a different character classification that is related to the third character.

In FIG. 2, for convenience of description, the character code representing the third character is referred to as a first character code, and a character code representing the different character classification related to the third character is referred to as a second character code.

In this case, the receiving unit 210 receives a request for the second character code from the client 100. The information acquisition unit 220 acquires the second character code, based on the first character code. The transmitting unit 230 transmits the second character code to the client 100.

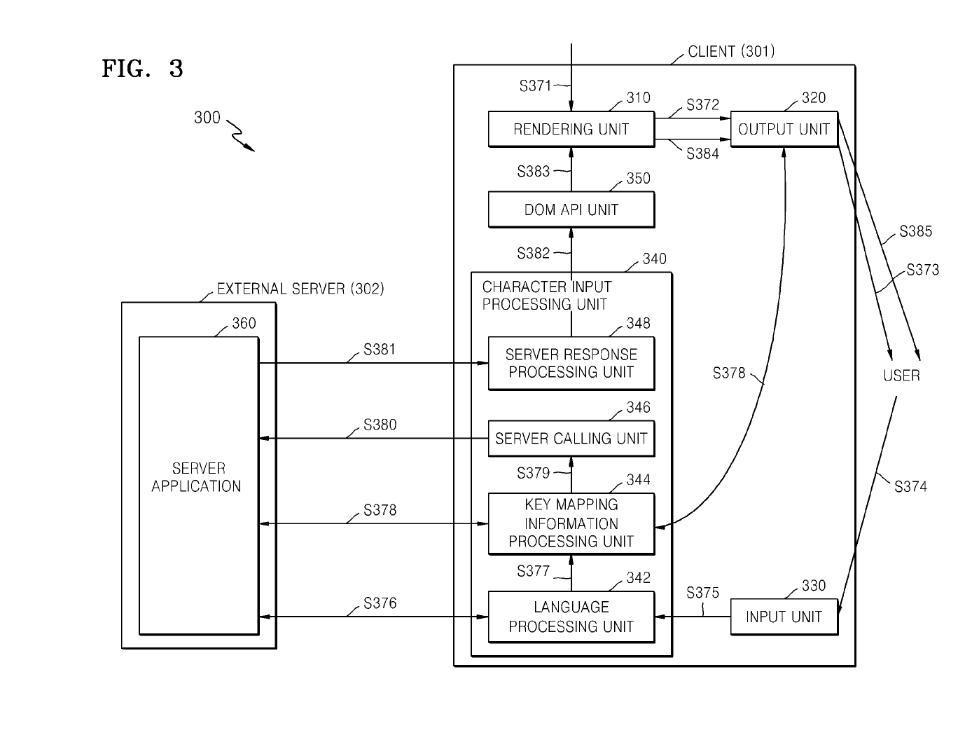

FIG. 3 is a block diagram of a system 300 including a client 301 and an external server 302, according to an exemplary embodiment of the present invention.

A rendering unit 310 assigns a memory to a screen in order to output web contents on the screen, and stores data of the web contents to be output in the assigned memory. When resources are received by the rendering unit 310, wherein the resources constitute a web page requested by a user via a web browser, the rendering unit 310 performs the above-described rendering required for outputting the web page. The resources received by the rendering unit 310 may include a hypertext markup language (HTML) type text, an extensible markup language (XML) type text, an image file, a moving picture or the like.

The output unit 320 outputs the web contents received by the rendering unit 310.

The input unit 330 is an element through which a user may input numbers and/or characters.

A character input processing unit 340 is an element for processing the character that is input by the user and then displaying the processed character.

In one exemplary embodiment, the character input processing unit 340 can be embodied by virtue of asynchronous javascript and XML (AJAX). Through use of AJAX, data can be changed into an XML type format and can be controlled using a java script, extensible hypertext markup language (XHTML), or the like in a web page, and thus a user can see a refreshed image without refreshing the web page. For example, when a user selects a key, a character is refreshed in real time in response to the selected key.

The character input processing unit 340 includes a language processing unit 342, a key mapping information processing unit 344, a server calling unit 346, and a server response processing unit 348.

The language processing unit 342 determines whether the client 301 can independently process a character of a classification that is to be input by a user.

The key mapping information processing unit 344 outputs mapping information between keys and characters of the classification that is input to the output unit 320.

The server calling unit 346 requests the external server 302 for a character code corresponding to the character input by the user.

The server response processing unit 348 receives the character code corresponding to the character input by the user from the external server 302, and transmits the character code to a document object model (DOM) application programming interface (API) unit 350.

The DOM API unit 350 provides and processes an API to meet a DOM standard. The DOM standard is an object-based text model for cross application of an XML text via a web browser. In the DOM standard, contents of a web page are treated as an object, and thus the contents of the web page can be easily changed. For example, a web page location at which a character is input is treated as an object. When a user inputs the character classification at the web page location, the character is displayed at the web page location by changing an object value.

Hereinafter, a method of processing character-input in the system 300 will be described.

In operation S371, when a user makes a request for web contents by using a method of inputting a uniform resources locator (URL), or the like, resources constituting the requested web contents are received by the rendering unit 310.

In operation S372, parsing and rendering are performed with respect to the received resources, and then the resources are transmitted to the output unit 320.

In operation S373, a web page is output to the output unit 320.

In operation S374, the user moves a cursor to a field on which a character can be input in the web page (for example, a field used for chatting with another user or transmitting a message). When the cursor is positioned at the field on which the character can be input, key mapping information is displayed so that the user can input the character. Initially, key mapping information regarding a classification of character that is previously set may be displayed. When the user wants to input a character of a different classification from the character that is previously set, he or she changes the classification of character that is previously set into a desired classification.

In operation S375, when a classification selection signal is detected by the character input processing unit 340, information regarding a classification of character that is selected is transmitted to the language processing unit 342.

In operation S376, it is checked whether the client 301 can independently the classification of the character that is selected by the user. When the client 301 can independently process the selected classification of the character, the client 301 independently processes the character-input. However, when the client 301 cannot independently process the selected classification, the client 301 asks the external server 302 whether the external server 302 can process the selected classification of character.

In operation S377, when the external server 302 can process the selected classification of character, the information regarding the selected classification of the character is transmitted to the key mapping information processing unit 344.

In operation S378, the key mapping information processing unit 344 interfaces with the external server 302 and acquires the key mapping information. The key mapping information includes information regarding a mapping between characters or phonemes and keys or buttons which are input by a user. The key mapping information is displayed on the output unit 320 so as to allow the user to select a key.

In operation S379, when the user checks the key mapping information displayed on the output unit 320, and then selects the key, a key value corresponding to the selected key is transmitted to the server calling unit 346.

In operation S380, the server calling unit 346 transmits character classification information and key selection information to the external server 302. The character classification information may be information regarding classification of a language such as Korean or Japanese, or alternatively may be information regarding a manner of inputting a character, such as a two set type or a three set type.

In operation S381, a server application unit 360 acquires a character code of a character that is desired by the user by using the information transmitted by the client 301, and transmits the character code to the server response processing unit 348.

In operation S382, the server response processing unit 348 transmits data regarding the character code received from the server application unit 360 to the DOM API unit 350.

In operation S383, the DOM API unit 350 reflects the data transmitted by the server application unit 360 to an element of an image, at which the cursor is currently positioned.

In operation S384, the rendering unit 310 performs rendering so that an updated image is displayed.

In operation S385, the user can check an image on which the character is displayed in response to user's input.

The user can change the character displayed on a screen into a different classification of character related to the displayed character. When a Japanese character is input, ‘Hiragana’ and ‘Katakana’ can be converted into each other, or ‘Hiragana’ can be converted into a ‘Chinese character’. When the user selects a conversion button via the input unit 330, operation S380 is again performed.

In operation S380, the server calling unit 346 transmits a character code of the character displayed on the screen to the external server 302.

In operation S381, the server response processing unit 348 receives information regarding convertible characters from the external server 302. The convertible characters may be shown to the user through operation S382 through S385. When at least one convertible character exists, a list including the at least one convertible character may be shown in the form of a convertible list to the user. When the user selects a character to be converted from the convertible list, the selected character is input.

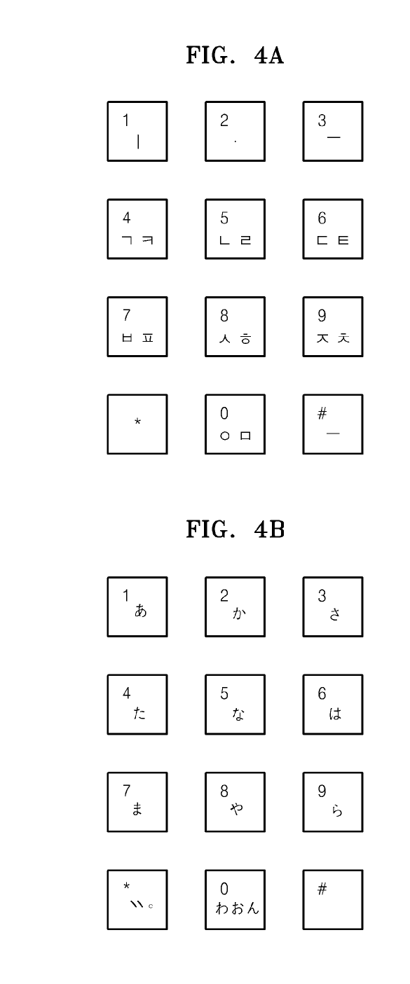

FIGS. 4A and 4B illustrate a method of processing character-input, according to exemplary embodiments of the present invention.

A user moves a cursor to a field in which a character can be input, wherein the field is present on a web page being displayed on a TV. The user can move the cursor to the field by direction keys or the like of a remote controller.

When the user moves the cursor, key mapping information is displayed on a part of a screen. Initially, key mapping information between keys and characters of a classification that is previously set may be displayed. If the classification that is previously set is English, mapping information between letters of the alphabet and keys may be displayed.

FIG. 4A illustrates Korean characters assigned to keys of the remote controller used for inputting characters, according to an exemplary embodiment of the present invention.

In FIG. 4A, a user wants to input a Korean character. The user selects Korean by a button for selecting a classification of character to be input. The user wants to search a broadcasting program by using a keyword such as [symbol] 9’ which is the name of a news broadcasting program (which means “News 9”).

Table 1 shows the forms of data received by a client from the user, a server application, and the automata, in response to the user's input, and the resulting display on the display unit.

TABLE 1

| User's | Client (from | | | Display |
|---|---|---|---|---|
| input | user) | Server application | automata | unit |
| KO | Buffer Clear | | | |
| 5 | KO, 5 | KO, ‘ [symbol] ’ | ‘ [symbol] ’ | [symbol] |
| 3 | KO, 5, 3 | KO, ‘ [symbol] ’, ‘ [symbol] ’ | ‘ [symbol] ’ | [symbol] |
| 2 | KO, 5, 3, 2 | KO, ‘ [symbol] ’, ‘ [symbol] ’, | ‘ [symbol] ’ | [symbol] |
| | | ‘.’ | | |
| 2 | KO, 5, 3, 2, 2 | KO, ‘ [symbol] ’, ‘ [symbol] ’, | ‘ [symbol] ’ | [symbol] |
| | | ‘.’, ‘.’ | | |
| 8 | KO, 5, 3, 2, 2, 8 | KO, ‘ [symbol] ’, ‘ [symbol] ’, | ‘ [symbol] ’ | [symbol] |
| | | ‘.’, ‘.’, ‘ [symbol] ’ | | |
| 3 | KO, 5, 3, 2, 2, 8, 3 | KO, ‘ [symbol] ’, ‘ [symbol] ’, | ‘ [symbol] ’ | [symbol] |
| | | ‘.’, ‘.’, ‘ [symbol] ’, ‘ [symbol] ’ | | |
| NU | Buffer Clear | | | |
| 9 | 9 | | | [symbol] 9 |

As shown in Table 1, the user selects the classification of character to be input as Korean (KO), a buffer in the client is initialized. When the user selects ‘5’, a key value corresponding to ‘5’ may be generated in the client. The client transmits information regarding Korean as a classification of character and the key value corresponding to ‘5’ to the server application.

The server application generates a character code corresponding to ‘5’ and then transmits the character code to the automata. Referring to FIG. 4A, it can be seen that a Korean character corresponding to ‘5’ is [symbol] Thus, a character code corresponding to [symbol] is transmitted to the automata.

The automata combines characters by using the transmitted character code so as to generate a character code of a completed character. Since there is no previous input, a character code representing [symbol] is a character code representing the completed character.

The character code representing the completed character is transmitted to the client, and then the client displays [symbol] on a display unit.

Next, when the user selects ‘3’, a key value corresponding to ‘3’ is generated in the client. The client transmits information regarding Korean as a classification of character and the key values corresponding to ‘5’ and ‘3’ to the server application.

The server application generates character codes corresponding to ‘5’ and ‘3’ and then transmits the character codes to the automata. Referring to FIG. 4A, it can be seen that Koran characters corresponding to ‘5’ and ‘3’ are [symbol] and ‘—’, respectively. Thus, the sever application transmits character codes corresponding to the [symbol] and ‘—’ characters to the automata.

The automata combines characters by using the transmitted character code so as to generate a character code of a completed character. Since the character codes corresponding to [symbol] and ‘—’ are transmitted, the automata combines [symbol] and ‘—’ so as to generate a character code of [symbol] that is the completed character.

The character code representing the completed character is transmitted to the client, and then the client displays [symbol] on the display unit.

Next, the user sequentially pushes buttons ‘2’, ‘2’, ‘8’ and ‘3’, and then [symbol] is displayed on the client according to the above-described method.

In order to input a number ‘9’, the user changes the classification of character to be input from ‘Korean’ to ‘number’. The user can select input of ‘number’ by using a character classification conversion button present on the web page, for example.

Thereafter, the user pushes a button ‘9’. Since a separate character input device is not required for inputting a number, the client directly outputs ‘9’ on a screen. Thus, [symbol] 9’ is displayed on the screen.

FIG. 4B illustrates Hiragana characters assigned to keys used for inputting characters, according to another exemplary embodiment of the present invention.

In FIG. 4B, a user wants to input a Japanese character. The user selects Japanese by using a button for selecting a classification of a character to be input. The user wants to input ‘ [symbol] [symbol] means blossom in Japanese.

When the user pushes a button ‘1’, information regarding ‘Hiragana’ as a classification of a character and a key value corresponding to ‘1’ are transmitted to the server application. The server application acquires a character code corresponding to ‘Hiragana’ and the number ‘1’. Referring to FIG. 4B, it can be seen that a character corresponding to ‘Hiragana’ and the number ‘1’ is [symbol] . The server application transmits a character code corresponding to [symbol] to the client, and then the client outputs [symbol] on a screen.

When the user again pushes the button ‘1’ within a predetermined period of time, information regarding that pushing of the button ‘1’ was repeated is transmitted to the server application. When the same key is repeatedly pushed within a predetermined period of time, it is assumed that characters (e.g., [symbol] . . . ’ in the case of a row [symbol] of a corresponding row are rotationally input. For example, if the user pushes the button ‘1’ once, the character [symbol] is input. But if the user pushes the button ‘1’ twice, the character [symbol] is input. The server application acquires a character code representing [symbol] corresponding to the user's input based on the received information from the client. The server application transmits the character code corresponding to [symbol] to the client.

Likewise, the user sequentially pushes buttons ‘3’, ‘2’, ‘2’, ‘2’, and ‘9’, and then [symbol] is displayed on a screen. In the current state, the user pushes a conversion button, characters of a different classification related to [symbol] are displayed. That is, a convertible character list is displayed, such as [symbol] [symbol] , ‘cherry blossom’ and the like. When the user selects one character from the convertible character list, the selected character is displayed in the field for inputting a character.

This can be applied to input Chinese characters. When a user inputs ‘hao’ corresponding to sounds of Chinese characters that are to be input and then pushes a conversion button, a list of Chinese characters, which are related to ‘hao’ and which all have the sound of ‘hao’, are displayed. When the user selects one character from the list, the selected character is displayed on the field for inputting a character. Likewise, a Korean character can be converted into a Chinese character by using the above-described method.

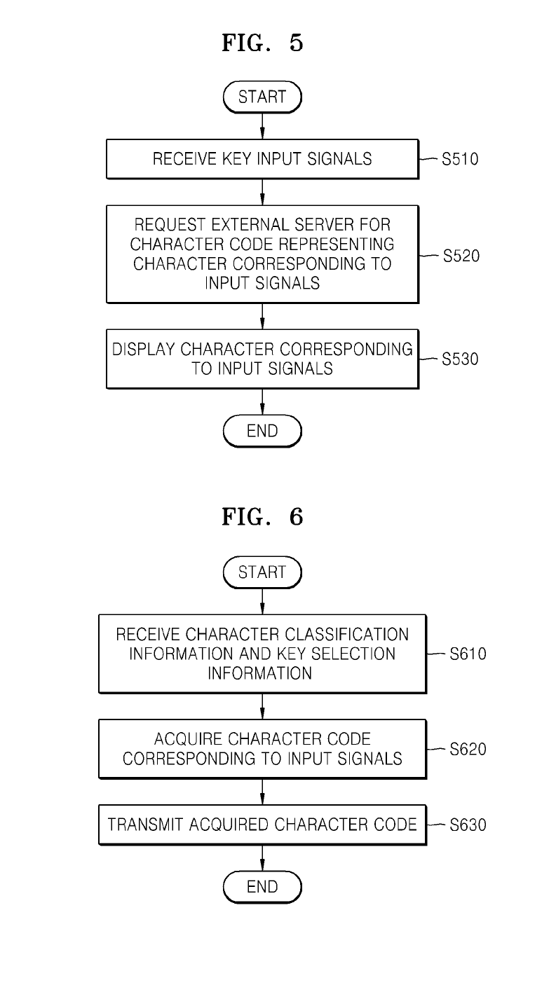

FIG. 5 is a flowchart of a method of processing character-input according to an exemplary embodiment of the present invention.

In operation S510, a classification selection signal and a key selection signal are received, wherein the classification selection signal is used for selecting the classification of character to be input and the key selection signal represents a selection of a key among keys each of which is assigned to represent at least one character of the selected classification.

In particular, when the classification selection signal for selecting the classification of character to be input is received, key mapping information between characters of the selected classification and keys to be used is requested from an external server. When the key mapping information is received, information regarding characters which are assigned to each key is displayed, thereby allowing the user to perform input (at least one character is assigned to each key). Next, the key selection signal indicating selection of one of the keys is received.

In operation S520, a character code representing a character corresponding to the classification selection signal and the key selection signal is requested from the external server. Simultaneously, information regarding the classification of character that is selected based on the classification selection signal and information regarding the key selected based on the key selection signal are transmitted to the external server. At this time, the transmitted information regarding the selected key may include information of a key that is currently selected and information regarding a key that was previously selected and stored in a database.

The method of processing character-input may include an operation in which it is determined whether the character of the selected classification can be independently processed, based on the classification selection signal, between operation S510 and S520. When it is determined that the character of the selected classification can be independently processed, operation S520 is not performed. In this case, the client displays the character corresponding to the selected classification and the selected key without receiving information from the external server

In operation S530, when the character code is received from the external server, a character corresponding to the classification and key selection signals is displayed, based on the received information. The received character code may include a character code representing a third character that is a combined character of a first character and a second character, wherein the first character corresponds to the character classification information and the information regarding the key that is currently selected and the second character corresponds to the character classification information and the information regarding the key that was previously selected. To display the character, information regarding the shape of each character is acquired, and then the character is displayed based on the received character code and the acquired information regarding the shape.

A user can convert the displayed character into a different classification related to the displayed character.

When receiving a character conversion signal for converting the displayed character into the different classification related to the displayed character from the user, a character code representing the different classification related to the displayed character is requested to the external server. When the character code representing the different classification related to the displayed character is received, the different classification of character is displayed based on the received character code.

FIG. 6 is a flowchart of a method of controlling a client processing character-input, according to an exemplary embodiment of the present invention. The client may include a key used for inputting a character and which is assigned to at least one character of a selected classification.

In operation S610, character classification information and key selection information are received, wherein the character classification information represents the classification of character that is selected based on a first selection signal from the client and the key selection information represents the selected key based on a second signal from the client.

In particular, the received character classification information represents the classification of a character that is selected based on the first selection signal. When the character classification information is received, key mapping information is transmitted to the client, wherein the key mapping information represents mapping between characters of the selected classification and keys used for inputting characters. Next, key selection information is received, wherein the key selection information represents the key that is selected by the user and is determined through the second selection signal generated based on the key mapping information.

The key selection information may include information regarding a key that is currently selected and information regarding a key that was previously selected.

In operation S620, a character code corresponding to the first selection signal and the second selection signal is acquired, based on the received character classification information and the key selection information. In particular, when the key selection information includes information regarding a key that is currently selected and information regarding a key that was previously selected, a character code representing a third character that is a combined character of the first character and the second character is acquired, wherein the first character corresponds to the character classification information and the information regarding the key that is currently selected and the second character corresponds to the character classification information and the information regarding the key that was previously selected.

In operation S630, a character code representing a character corresponding to the classification and key selection signals is transmitted to the client. The character corresponding to the classification and key selection signals may be the third character. The client may make a request for information regarding a character code of a different classification related to the third character. A character code representing the different classification related to the third character is acquired, based on the character code representing the third character, and then is transmitted.

The exemplary embodiments of the present invention can be written as computer programs and can be implemented in general-use digital computers that execute the programs using a computer readable recording medium.

Examples of the computer readable recording medium include magnetic storage media (e.g., ROM, floppy disks, hard disks, etc.), and optical recording media (e.g., CD-ROMs, or DVDs.

By receiving a character code corresponding to selection signals from an external server, characters of all languages from all countries and regions can be input/output to and from a terminal unit without a character input device installed in the terminal unit.

Moreover, since a character input device is not installed in a terminal unit, the development and production costs of such terminal units can be reduced.

In addition, since a character input device is not installed in a terminal unit, manufactures do not have to consider in which countries or regions the terminal unit is to be sold.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of processing character-input, the method comprising:
receiving a first signal representing a classification of a character to be input and a second signal representing a key selected from a plurality of keys to which a character of the classification is assigned;
requesting an external device for a first character code representing the character corresponding to the first signal and the second signal;
receiving the first character code from the external device; and
displaying the character corresponding to the first signal and the second signal based on the received first character code.

2. The method of claim 1, wherein the requesting comprises transmitting information related to the classification of the character to be input based on the first signal and information related to the selected key based on the second signal to the external device.

3. The method of claim 2, wherein the requesting further comprises storing the information related to the selected key based on the second signal, and when a third signal, separate from the second signal, representing a key selected from the plurality of the keys to which a second character of the classification is assigned is received after receiving the second signal, the requesting comprises transmitting the stored information related to the selected key based on the second signal, and information related to the selected key based on the third signal to the external device.

4. The method of claim 3, wherein the first character code is a character code representing a third character that is a combined character of a first character and a second character, wherein the first character corresponds to the information related to the classification of the character to be input and the information related to the selected key based on the second signal and the second character corresponds to the information related to the classification of the character to be input and the information related to the selected key based on the third signal.

5. The method of claim 1, wherein the receiving comprises:
receiving the first signal representing the classification of the character to be input;
requesting the external device for key mapping information relating characters of the classification represented by the first signal to the plurality of the keys used for inputting the characters;
receiving the key mapping information from the external device;
displaying information related to at least one character assigned to each respective key, based on the received key mapping information; and
receiving the second signal representing the selected key among the plurality of the keys.

6. The method of claim 1, further comprising determining whether the character-corresponding to the first signal and the second signal is capable of being independently processed, based on the received first signal,
wherein the requesting is performed when it is determined that the character-corresponding to the first signal and the second signal is not capable of being independently processed.

7. The method of claim 1, further comprising:
acquiring information related to the shapes of characters of the classification,
wherein the displaying includes displaying the character-corresponding to the first signal and the second signal, based on the acquired information related to the shapes of the characters.

8. The method of claim 1, further comprising:
receiving a character conversion signal for converting the displayed character into a different classification related to the displayed character;
requesting the external device for a second character code representing a character of the different classification, which is related to the displayed character;
receiving the second character code from the external device; and
displaying the character of the different classification, which is related to the displayed character, based on the received second character code.

9. A method of controlling an external apparatus which processes character-input, the method comprising:
receiving information related to a classification of a character that is selected based on a first selection signal transmitted from the apparatus and information related to a selected key based on a second selection signal transmitted from the external apparatus;
acquiring a first character code representing a character corresponding to the first selection signal and the second selection signal, based on the information related to the classification of the character and the information related to the selected key; and
transmitting the acquired first character code to the apparatus.

10. The method of claim 9, wherein the information related to the selected key includes information related to the key that is currently selected and information related to a key that was previously selected, and
the first character code represents a third character that is a combined character of a first character and a second character, wherein the first character corresponds to the information related to the classification of the character and the information related to the selected key that is currently selected and the second character corresponds to the information related to the classification information of the character and the information related to the key that was previously selected.

11. The method of claim 10, further comprising:
receiving a request from the external apparatus for a second character code representing a different classification related to the third character;
acquiring the second character code based on the first character code; and
transmitting the second character code to the external apparatus.

12. The method of claim 9, wherein the receiving comprises:
receiving information related to the classification of the character based on the first selection signal;
transmitting key mapping information relating characters of the selected classification to keys used for inputting characters; and
receiving the information related to the selected key based on the second selection signal that is input according to the key mapping information.

13. An apparatus for processing character-input, the apparatus comprising:
an interface unit which receives a first signal representing a classification of a character to be input and a second signal representing a key selected from a plurality of keys to which a character of the classification is assigned;
an information requesting unit which requests an external device for a first character code representing the character corresponding to the first signal and the second signal;
a display unit which displays the character corresponding to the classification selection signal and the key selection signal; and
a controlling unit which controls the display unit to display the character corresponding to the first signal and the second signal, when the first character code is received.

14. The apparatus of claim 13, wherein the information requesting unit comprises an information transmitting unit which transmits information related to the classification of the character to be input based on the first signal and information related to the selected key based on the second signal to the external device.

15. The apparatus of claim 14, further comprising a database storing the information related to the selected key based on the second signal, and when a third signal, separate from the second signal, representing a key selected from the plurality of the keys to which a second character of the classification is assigned is received by the interface unit after receiving the second signal, the information transmitting unit transmits the stored information related to the selected key based on the second signal, and information related to the selected key based on the third signal to the external device.

16. The apparatus of claim 15, the first character code is a character code representing a third character that is a combined character of a first character and a second character, wherein the first character corresponds to the information related to the classification of the character to be input and the information related to the selected key based on the second signal and the second character corresponds to the information related to the classification of the character to be input and the information related to the selected key based on the third signal.

17. The apparatus of claim 13, wherein the information requesting unit requesting the external device for key mapping information relating characters of the classification represented by the first signal to the plurality of the keys used for inputting the characters when the first signal is received by the interface unit, and
the controlling unit controls the display unit to display information related to at least one character assigned to each respective key, based on the received key mapping information, when the key mapping information is received.

18. The apparatus of claim 13, further comprising a determining unit which determines whether the character-corresponding to the first signal and the second signal is capable of being independently processed by the controlling unit based on the received first signal,
wherein the determining unit requests the external device for the first character code when it is determined that the character-corresponding to the first signal and the second signal is not capable of being independently processed by the controlling unit.

19. The apparatus of claim 13, further comprising:
a database storing information related to the shapes of characters of the classification,
wherein the controlling unit controls the display unit to display the character-corresponding to the first signal and the second signal based on the acquired information related to the shapes of the characters.

20. The apparatus of claim 13, wherein the interface unit further receives a character conversion signal for converting the displayed character into a different classification related to the displayed character,
the information requesting unit requests the external device for a second character code representing a character of the different classification, which is related to the displayed character, and
the controlling unit controls the display unit to display the character of the different classification, which is related to the displayed character, based on the second character code, when the second character code is received.

21. An apparatus for controlling another external apparatus for processing character-input, the apparatus comprising:
a receiving unit which receives information related to a classification of a character to be input that is based on a first selection signal transmitted from the external apparatus and information related to a selected key based on a second selection signal transmitted from the external apparatus;
an information acquisition unit which acquires a first character code representing a character corresponding to the first selection signal and the second selection signal based on the information related to the classification of the character and the information related to the selected key; and
a transmitting unit which transmits the first character code to the external apparatus.

22. The apparatus of claim 21, wherein the information related to the selected key includes information related to the key that is currently selected and information related to a key that was previously selected, and
the first character code represents a third character that is a combined character of a first character and a second character, wherein the first character corresponds to the information related to the classification of the character and the information related to the selected key that is currently selected and the second character corresponds to the information related to the classification information of the character and the information related to the key that was previously selected.

23. The apparatus of claim 22, wherein the receiving unit comprises a conversion-request receiving unit which receives a request from the external apparatus for a second character code representing a different classification related to the third character,
the information acquisition unit acquires the second character code based on the first character code, and
the transmitting unit transmits the second character code to the external apparatus.

24. The apparatus of claim 21, wherein the transmitting unit transmits key mapping information relating characters of the selected classification to keys used for inputting characters when the receiving unit receives the information related to the classification of the character based on the first selection signal, and
the receiving unit receives the information related to the selected key based on the second selection signal that is input according to the key mapping information.

25. A computer readable storage medium storing a program for implementing functions of character-input processing, said functions comprising:
receiving a first signal representing a classification of a character to be input and a second signal representing a key selected from a plurality of keys to which a character of the classification is assigned;
requesting an external device for a first character code representing the character corresponding to the first signal and the second signal;
receiving the first character code from the external device; and
displaying the character corresponding to the first signal and the second signal based on the received first character code.

26. A computer readable storage medium storing a program for implementing functions of controlling a character-input processing apparatus, said functions comprising:
receiving information related to a classification of a character that is selected based on a first selection signal transmitted from the apparatus and information related to a selected key based on a second selection signal transmitted from the external apparatus;
acquiring a first character code representing a character corresponding to the first selection signal and the second selection signal, based on the information related to the classification of the character and the information related to the selected key; and
transmitting the acquired first character code to the apparatus.
